(19) United States
(12) Patent Application Publication
(10) Pub. No.: US 2017/0298307 A1
(43) Pub. Date: Oct. 19, 2017

(54) PROCESS FOR USING SWELLABLE and COLLAPSIBLE LIPOPHILIC SUPER-ABSORBENT POLYMER GELS TO CLEAN SURFACES

(71) Applicant: United States of America as Represented by The Secretary of The Army, Alexandria, VA (US)

(72) Inventors: Veera Mallu Boddu, Champaign, IL (US); Sophie Minori Uchimaya, River Ridge, LA (US); Mashiko Ohto, Sapporo (JP); Kazuki Sada, Sapporo (JP)

(21) Appl. No.: 15/098,225

(22) Filed: Apr. 13, 2016

(51) Int. Cl. C11D 17/00; B08B 7/00; C11D 3/37; C11D 3/43

(52) U.S. Cl. CPC C11D 17/003; C11D 3/43; B08B 7/0014; C11D 3/3757

(57) ABSTRACT

Lipophilic super-absorbent swelling gels have been developed that will not only absorb the oil and grease from these machine parts, but will also act as an automated sweeper due to the self-generating mechanical force of the gel. An octadecylacrylate-co-ethylene glycol dimethacrylate (ODA-co-EGDMA) tetraalkylammonium tetraphenylborate lipophilic polyelectrolyte gel (EG-18) and poly(stearylacrylate-co-ethylene glycol dimethacrylate) (SA-co-EGDMA) neutral gel (NG-18) were evaluated for swelling and oil sorption capacity. NG-18 and EG-18 gels removed particulate contaminants and absorbed oils and grease on metal and non-metal surfaces without causing abrasion. The gels are also recyclable. The cleaning ability of the gels was compared with the standard solvent cleaner trichloroethylene (TCE) following ASTM G122-96(2008) test methods and MIL-PRF-680B procedure with MIL-PRF-10924 test grease. Polymer gel cleaners exhibited analogous extent and rate of cleaning as the TCE. These recyclable superabsorbent polymer cleaners will allow drastic reduction in the use of VOC containing solvents and HAP release.

### CROSS-REFERENCE TO RELATED APPLICATIONS

This application is a continuation-in-part and claims the benefit of U.S. patent application Ser. No. 14/054,794 filed Oct. 15, 2013. The above application is incorporated by reference herein.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### BACKGROUND OF THE INVENTION

### 3. Field of Invention

This invention relates to the field of processes for using cleaning compositions for solid surfaces, and more specifically to a process using a gel composition.

### 4. Description of Related Art

Increasingly stringent environmental regulations on volatile organic compounds (VOCs) and hazardous air pollutants (HAPs) demand the development of non-disruptive technologies for cleaning weapons systems and platforms. Currently employed techniques such as vapor degreasing, solvent, aqueous, or blast cleaning processes suffer from shortcomings in environmental friendliness, personnel health and safety, cleaning efficiency, cost-effectiveness, management of contaminated cleaning media, or in maintaining the integrity of equipment material surfaces.

Environmentally benign VOC-exempt, and HAP-free surface cleaning technology, will support ongoing Department of Defense (DoD) programs such as the Sustainable Painting Operations for the Total Army (SPOTA). Technology developed in this research will result in dramatic overall reductions of VOCs and HAPs emissions from DoD surface cleaning operations. Polyelectrolyte gels are ionic polymer networks composed of charged polymer chains and freely mobile counter-ions. Polyelectrolyte super-absorbent wet-swelling hydrogels are known to undergo a dramatic but reversible volume change by absorbing large quantities of water. The polyelectrolyte hydrogels swell in water because of (1) osmotic pressure induced by freely mobile counter-ions within the polyelectrolyte, (2) increased entropy arising from the solvation of polymer ions and counter-ions, (3) electrostatic repulsion between the oppositely charged ions within the polyelectrolyte gel, and (4) stretching of polymer chains between crosslinks caused by the increase in entropy associated with mixing polymer with solvent. Polyelectrolyte hydrogels have found a wide range of applications in diapers, inks and display devices, separation media, and cleanup of aqueous spills. Polyelectrolyte hydrogels are particularly useful for a wide range of environmental applications, because expansion and contraction of the gels can be engineered to be triggered by small changes in environmental parameters such as temperature, pH, and ionic strength. However, until recently, reports on gels that will swell by absorbing large quantities of nonpolar organic solvents were nearly nonexistent. In nonpolar solvents, most polyelectrolyte gels collapse, because the oppositely charged ions within the gel form ion pairs that then aggregate, rather than becoming solvated.

In 2007, researchers [3] reported, for the first time, a novel class of lipophilic polyelectrolyte gels bearing positively charged repeating units (substituted tetraalkylammonium with long alkyl chains) and negatively charged counter-ions (substituted tetraphenylborate; TFPB⁻) that swell dramatically but reversibly by absorbing organic solvents having various polarities (ε=1.9-46; the lower the dielectric constant (ε), the less polar the solvent). Superior swelling ability in nonpolar solvents (illustrated in FIGS. 1a and 1b) is enabled by making both the polymer chains and the counter-ions lipophilic, preventing counter-ions from forming ion pairs, thereby enabling the solvation of ionic gel components in solvents. Lipophilic polyelectrolyte gel presented in FIGS. 1a and 1b is hereby termed EG-18 and will serve as a candidate cleaner in this proposal. FIGS. 1c and 1d illustrate swelling behavior of NG-18, a neutral analogue of EG-18 that does not contain the ionic tetraalkylammonium tetraphenylborate unit. As shown in FIGS. 1a-1d, neutral gel NG-18 swells to a much lesser extent than the ionic EG-18 gel. Neutral polymer gels swell in organic solvents because of the stretching of polymer chains between crosslinks caused by the increase in entropy associated with mixing polymer with solvent. Additional swelling mechanisms of polyelectrolyte gels such as the solvation of ionic groups do not exist in neutral gels. Therefore, neutral gels may be of limited use as cleaners compared to polyelectrolyte gels, but can be used as a measure of swelling capacity arising from the compatibility of the polymer chains with solvents alone.

We propose to use novel lipophilic super-absorbent swelling gels as a disruptive solid state cleaning technology that will facilitate the DoD in overcoming limitations of currently employed cleaning techniques.

### BRIEF SUMMARY OF THE INVENTION

The present invention is a cleaning process for a surface having contaminants thereon using a lipophilic, highly absorbent swelling gel having solvent absorbed therein. The process comprises the steps of (i) combining a dry lipophilic, highly absorbent swelling gel with an initial amount of solvent to form a swollen gel, (ii) contacting the surface having contaminants thereon with the swollen gel, the swollen gel being at a cleaning temperature, (iii) the contaminated surface and the swollen gel remaining in contact for a period of time to remove the contaminants from the surface and transfer the contaminants to the swollen gel, and forming a dirty gel, and (iv) removing the surface from the dirty gel, wherein at least 80% by weight of the contaminants have been removed from the surface.

### BRIEF DESCRIPTION OF SEVERAL VIEWS OF THE DRAWING(S)

FIGS. 1a-1d illustrate a dry lipophilic polyelectrolyte gel (EG-18), EG-18 gel swollen in tetrahydrofuran (THF) (ε=7.6), a dry neutral analogue (NG-18), and NG-18 gel swollen in THF, respectively. Figures are in scale with one another.

FIG. 2 illustrates a preparation of candidate lipophilic tetraalkylammonium tetraphenylborate polyelectrolyte gel (EG-18) and its neutral analogue (NG-18).

FIG. 3 illustrates the swelling degree (Q) of lipophilic polyelectrolyte gels (EGn where n represents alkyl chain length of polyacrylate polymer backbone, as shown in FIG. 2) and neutral analogues (NGn) in organic solvents (in increasing order of polarity from left to right).

FIG. 4 illustrates an FTIR spectra of stearylacrylate

FIG. 5 illustrates the compression strength of swollen NG-18-1%. THF has a breaking point around 0.371 MPa.

FIG. 6 illustrates the swelling degree of NG-18-x % at 25° C. in various solvents after 24, 48 and 72 hours.

FIG. 7 illustrates the temperature dependence of swelling degree (Q) of NG-18-1% in various solvents.

FIG. 8 illustrates the thermal response of NG-18 gels.

FIG. 9 illustrates the swelling degree changes of NG-18 with time in THF

FIGS. 10a-10c illustrate the temperature dependence of transmittance at 700 nm of NG-18-1% gel swollen in THF, the transparent state at 25° C., and the opaque state at 0° C., respectively.

FIGS. 11a-11c illustrate the results of thermal cycling (25° C. to 0° C.) test for NG-18 gels: changes of (circle) transmittance at 700 nm, (triangle) swelling degree in THF, the transparent state at 9th step, and the opaque state at 10th step, respectively.

FIG. 12 illustrates the results of thermal cycling of (25° C. to 0° C.) NG-18-1% gel swollen in cyclohexane.

FIGS. 13a and 13b illustrate the compression strength of swollen NG-18-1% and NG-18-0.5% in toluene, respectively.

FIG. 14 illustrates the oil absorption properties of NG-18 gels.

FIG. 15 illustrates the metal surface cleaning properties of NG-18 gels.

FIGS. 16a-16j illustrate metal coupons. FIGS. 16a-16c illustrate metal coupons soaked in SAE-30 oil. FIGS. 16d-16f illustrate metal coupons soaked in the mixture of SAE-30 oil and alumina powder. FIGS. 16g-16i illustrate metal coupons immersed in NG-18-1% gel. FIG. 16j illustrates metal coupons immersed in NG-18-0.5% gel. Circles indicate the alumina remaining area.

FIGS. 17a, 17c, 17e, and 17g illustrate soiled metal parts before cleaning tests with NG-18-1% gels swollen in THF, while FIGS. 17b, 17d, 17f, and 17h illustrate the respective soiled metal parts of FIGS. 17a, 17c, 17e, and 17g after cleaning with NG-18-1% gels swollen in THF.

FIG. 18 illustrates the grease absorption properties of NG-18 gels.

FIG. 19 illustrates the grease cleaning power of NG-18 gels.

FIG. 20 illustrates the cyclic surface cleaning process with swollen NG-18-1% gel in THF.

FIGS. 21a and 21b illustrate metal coupons before and after, respectively, immersing the NG-18 gel: from left side, cycle 1-5, while FIG. 21c illustrates the absorbed amount in each cycle.

FIGS. 22a-22d illustrate the collected solution, filtrated residual particulates, residual oil after evaporation, and ratio of collected solution amount for the weight of gel during cyclic cleaning process, respectively.

FIG. 23 illustrates metal coupons immersed in gel: (left) NG-18-1%, (center) NG-18-0.5%, and (right) toluene.

FIGS. 24a and 24b illustrate a metal coupon after and before, respectively, being contaminated with MIL-PRF-10924 grease. FIGS. 24c and 24d illustrate metal coupons cleaned with NG-18-0.5% for 13 minutes and 32 seconds. FIGS. 24e and 24f illustrate metal coupons cleaned with trichloroethylene (TCE) for 5 minutes 12 seconds and NG-18-1% for 12 minutes 58 seconds, respectively.

### DETAILED DESCRIPTION OF THE INVENTION

The overall objective of the proposed research was to develop an environmentally benign disruptive technology for cleaning metal and non-metal surfaces. The ability of two super absorbent polymer gel systems for removing oil, grease and particulates from metal and plastic surfaces was initially evaluated. Upon successful proof of the surface cleaning ability of these gel systems, further research will focus on improving the gel performance by design and synthesis of additional polymer gel systems. Further research will address the post-cleaning gel removal method, the use of non-fluorinated compounds in gel synthesis, and an evaluation of toxicity and environmental fate-and-effects of the gels. The proposed cleaner is in solid form and is VOC-exempt, HAP-free, non-toxic, non-corrosive, non-ozone depleting, recyclable, and self-generates the energy necessary for the cleaning function, thereby affording a new cost-effective, environmentally friendly cleaning technology. We hypothesized that lipophilic super-absorbent swelling gels would, upon contacting oil and grease on the metal and non-metal surfaces, exert enough mechanical forces by swelling to remove particulate matters, oil, and grease on the material surfaces simultaneously. Also, that the super-absorbent gels would exhibit low friction behaviors and therefore not stick to, or cause damage on the surface of metal and nonmetal materials. Existing solvent and blast cleaning technologies pose environmental concerns both during (VOC production from organic solvents and HAP production from forced-air blast cleaning processes) and after (disposal of waste streams for solvent cleaning; cleanup of blasted contaminants for forced air cleaning) the cleaning operation. In addition, these techniques require on-site equipment such as the soaking bath and air compressor, and often necessitate operation in a confined, well-ventilated space. Current limitations stated above call for a portable cleaning technology that will not pose environmental or health threats during or after the cleaning operations. The overall study aimed to utilize intricate designing of lipophilic super-absorbent swelling gels through careful selection of polymer backbone and ionic components, and the cross linking density for improved cleaning ability of the lipophilic swelling gels. After successful proof-of-concept, a follow-on project will be proposed to address other issues including the method for removing the gels after swelling, the use of non-fluorinated compounds in gel synthesis, and an evaluation of toxicity and environmental fate-and-effects of the gels.

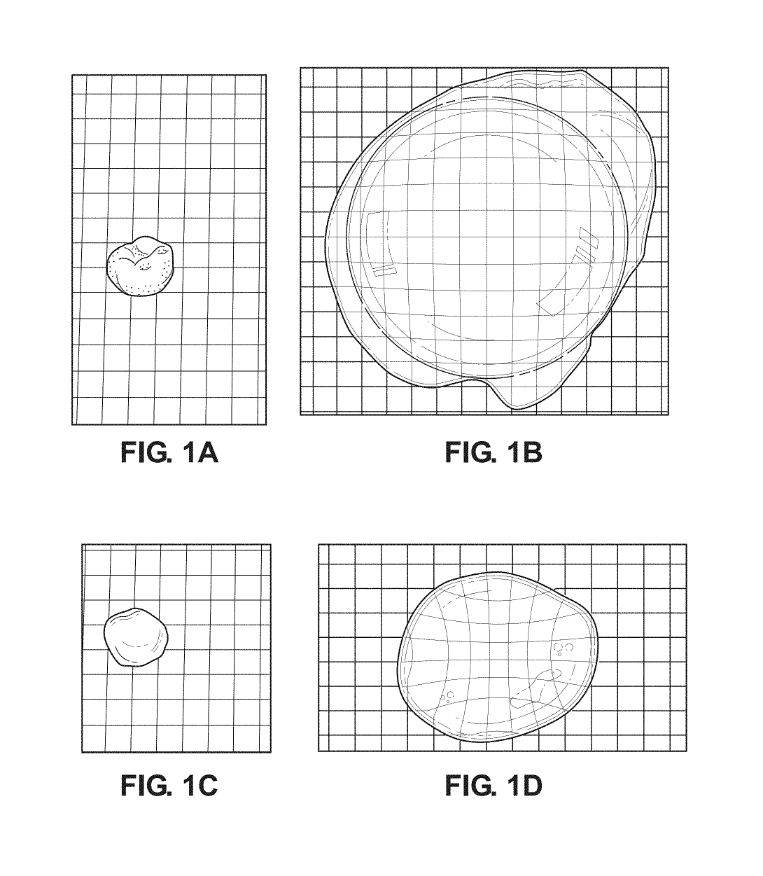

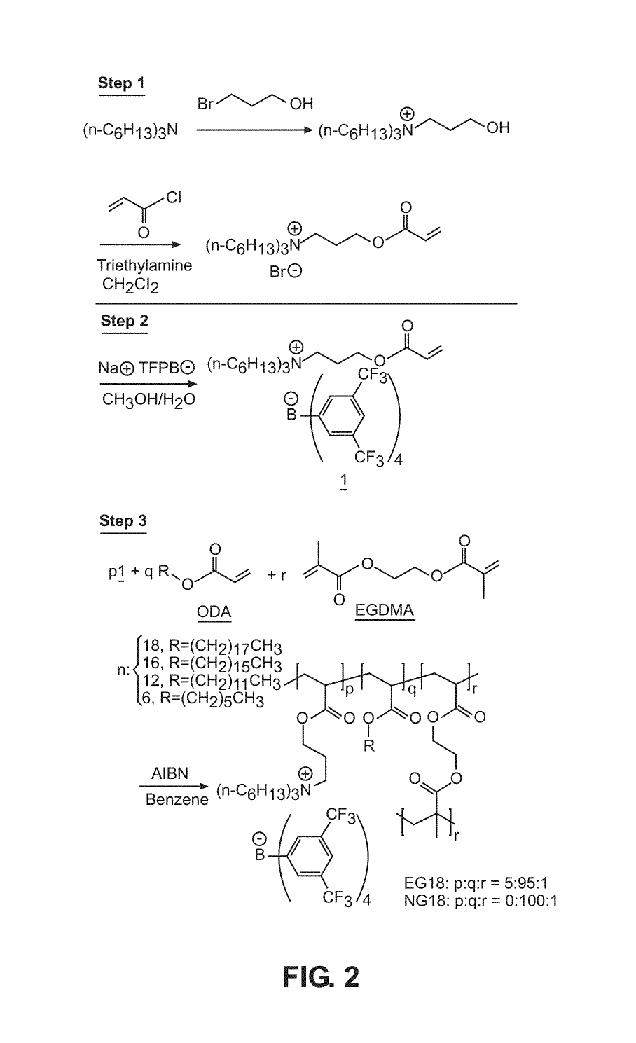

FIG. 2 presents pathways for preparing the lipophilic polyelectrolyte swelling gel octadecylacrylate-co-ethylene glycol dimethacrylate tetraalkylammonium tetraphenylborate (EG-18) whose swelling behavior in organic solvent was presented in FIG. 1 (top). As shown in FIG. 2, EG-18 can be prepared via the following steps:

Step 1: Synthesis of quaternary alkylammonium halide salt.

Step 2: Reaction of the product from Step 1 with substituted tetraphenylborate (TFPB⁻); weakly coordinating lipophilic anion) to form lipophilic ionic acrylate monomer.

Step 3: Copolymerization of the product from Step 2 with the polymer backbone octadecyl acrylate (ODA) using azobisisobutyronitrile (AIBN) as the initiator and ethylene glycol dimethacrylate (EGDMA) as the cross linker.

As illustrated in FIG. 2, the ratio of ionic unit tetraalkylammonium tetraphenylborate (p), polymer backbone ODA (q), to cross linker EGDMA (r) for EG-18 is kept at p:q:r=5:95:1 for EG-18 to maintain low content of ionic groups [4]. Ionic group content must be kept low to avoid aggregation of ionic groups. Neutral analogue stearylacrylate-co-ethylene glycol dimethacryale gel (NG-18) can be prepared by simply excluding the ionic tetraalkylammonium tetraphenylborate unit (p) for the feed ratio of p:q:r=0:100:1 (FIG. 2).

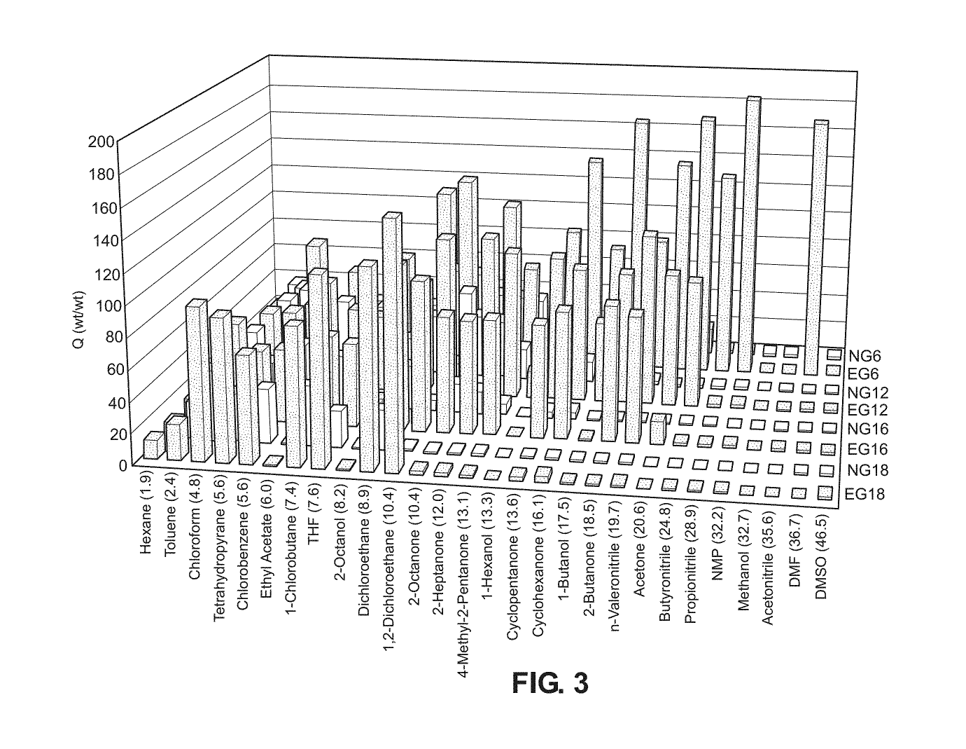

FIG. 3 illustrates the impact of cross-linked polyacrylate polymer backbones on the swelling degree of ionic (EGn) and neutral (NGn) gels. Gels presented in FIG. 3 possess polyacrylate backbones with alkyl chain lengths ranging from n=18 (R═(CH₂)₁₇CH₃), 16 (R═(CH₂)₁₅CH₃), 12 (R═(CH₂)₁₁CH₃), to 6 ((R═(CH₂)₅CH₃); see ODA structures in FIG. 2). Swelling degrees (Q in wt/wt) in FIG. 3 were quantitatively determined by soaking a selected gel in an appropriate solvent for a fixed time using the following equation:

$$Q = \frac{{W}_{wet} - {W}_{dry}}{{W}_{dry}} \qquad Eq . ( 1 )$$

where W_{dry} and W_{wet} are the weights of the dry and swollen gels, respectively.

FIG. 3 demonstrates that maximum absorbency of the polyelectrolyte gel (EGn) shifts toward solvents with lower polarity as alkyl chain length (i.e., lipophilicity) of polyacrylate backbone increases from n=6, 12, 16, to 18. That is, EG-18 exhibits maximum swelling by absorbing large quantities of organic solvents with dielectric constants between 3 and 10 (FIG. 3). On the other hand, EG6 shows maximum absorbency for much more polar solvents (ε=16-32). As shown in FIG. 3, for a given alkyl chain length (n), ionic gel (EGn) swells to a much greater degree than the neutral analogue (NGn), as demonstrated visually for EG-18 and NG-18 in FIG. 1. As shown in FIG. 3, in solvents having dielectric constants below 3, comparable degrees of swelling are observed for ionic and neutral gels. In such nonpolar solvents, dissociation of ions within EGn is suppressed and ionic groups are tightly bound as ion pairs. As a result, the swelling of EGn results only from stretching of polymer chains between crosslinks caused by the increase in entropy associated with mixing polymer with solvent.

The following conclusions can be made from the review of recent and ongoing studies on polyelectrolyte and neutral lipophilic swelling gels provided above:

(1) Swelling degree and absorbency of lipophilic polyelectrolyte gels are much greater than their neutral analogues.

(2) Increased lipophilicity of both polymer backbones and ionic groups results in greater swelling capacity and absorbency in solvents having low dielectric constants.

A promising candidate is the lipophilic super-absorbent gel that will swell by absorbing nonpolar organic solvents (e.g., hydrocarbon oils, VOCs) several hundred times their dry weight. This study aims to utilize intricate designing of lipophilic super-absorbent swelling gels through careful selection of polymer backbone and ionic components, and the cross linking density. Designed swelling gels will function as the cleaner of the metal and non-metal surfaces by (1) absorption of oil and grease and (2) removal of particulate contaminants by self-generated mechanical forces obtained from swelling in (1). After the cleaning operation, cleaning media can be safely collected and recycled or used in fuel blends.

In order to develop a new cleaning technology based on lipophilic super-absorbent swelling gels for the removal of oil, grease and particulate matter from metal and non-metal surfaces, specific tasks are formulated to maximize the cleaning efficiency of lipophilic gels by (1) testing cleaning ability of candidates EG-18 and NG-18 gels and (2) designing lipophilic gels with improved cleaning ability by appropriate selection of lipophilic polymer backbone, weakly coordinating anions, and enhancement of mechanical strength. Elimination of fluorinated compounds in the gel synthesis was the focus of this and subsequent phases of this research.

### Technical Approach

Our research has identified two potential gels, a lipophilic polyelectrolyte (EG-18) gel and a neutral (NG-18) polymer gel for surface cleaning applications. These gels were evaluated during this initial phase of the study following the American Society for Testing and Materials (ASTM) G122-96(2008) and MIL-PRF-680B protocols. Representative contaminants of oil, grease and particulate materials were selected. The proposed scope of the full project was to elucidate the chemical and physical mechanisms in the removal of oil, grease, and particulate contaminants from metal and non-metal surfaces by lipophilic super-absorbent swelling gels. Research outcomes will facilitate the development of environmentally compliant, economically feasible cleaners for a wide range of DoD applications, providing a promising alternative to traditional vapor degreasing, solvent, aqueous, or blast cleaning processes. EG-18 gel studies are not included in this report as these were reported by Sada and coworkers [3].

### Materials and Methods

All chemical reagents were used as received. Stearylacrylate (SA), ethylene glycol dimethacrylate (EGDMA), benzene, azobisisobutylonitrile (AIBN), methanol, ethanol, diethylether, and carbon tetrachloride were purchased from Sigma-Aldrich (Milwaukee, Wis.). Tetrahydrofuran (THF), isopropanol, acetonitrile, and dichloromethane were obtained from Acros Organics (Morris Plains, N.J.). Dimethylsulfoxide (DMSO) and 1-octanol were supplied from Alfa Aesar (Ward Hill, Mass.). Chloroform and cyclohexane were distributed from VWR International (West Chester, Pa.). Acetone, methylisobutylketone (MIBK), toluene, and n-hexane were supplied from Fisher Scientific (Pittsburgh, Pa.). An Instron 5900 Electromechanical System was used for the compression of the gels. A Jasco FT/IR-4100 Fourier Transform Infrared Spectrometer was used for infrared spectroscopy.

### Synthesis

A typical protocol for the synthesis of NG-18 gel is as follows: 10.0 g (30.8 mmol) of SA (monomer) and 61 mg (0.31 mmol, the case of x=1) of EGDMA (crosslinker) as initiator were placed in a vial tube and dissolved in 2 mL of benzene by heating at 50° C. Oxygen in the solution was excluded by bubbling nitrogen gas for 45 min then 101 mg (0.62 mmol) of AIBN was added. The vial tube was sealed tightly and heated at 65° C. for 24 h for polymerization. Gels with low crosslinking densities were prepared in a similar way by reducing the feed ratios of EGDMA. The synthesized gels were washed by swelling in hexane repeatedly, air-dried for 2 days, and dried in vacuum overnight. SA-co-EGDMA with two crosslinker ratios were prepared by radical copolymerization, which are represented as NG-18-x % (x=1 or 0.5; x denotes the mole ratio of crosslinker to SA.

A typical protocol for the synthesis of EG-18 gel is as follows: 125 mg (0.1 mmol) of TFPB⁻and 617 mg (1.9 mmol) of ODA, 3.96 mg (0.02 mmol) of EGDMA, and 6.57 mg (0.04 mmol) of AIBN were placed in a capillary of 7.0 mm in diameter and dissolved in benzene adjusted to 1.0 mL. The solution was degassed and polymerized by heating at 60° C. for 24 h. The feed ratio was adjusted to TFPB⁻:ODA:EGDMA=5:95:1. Gels with low crosslinking densities were prepared in a similar manner by reducing the feed ratios of EGDMA. The formed gels were washed by swelling in benzene for 10 h, and then air-dried at room temperature. The sample was cut into cylinders of about 1.0 mm in length, and the cylinders were dried in vacuo at 40° C.

Synthesis of EG-18 gel was performed by Sada and coworkers [3] at Kyushu University, Japan.

### Characterization

The Fourier transform infrared (FTIR) spectra were obtained using Jasco FT/IR-4100. Compression strength was measured with Instron 5900 electromechanical system and the compression speed was 0.25 mm/min. UV-vis spectra were collected using a ThermoSpectronic Aquamate 100 UV-vis Spectrometer.

### Swelling Studies

Swelling behavior of NG-18 gels was determined with the following solvents of various polarities at 25±1° C. using 5 mL vials: water, DMSO, methanol, ethanol, isopropanol, 1-octanol, acetone, MIBK, acetonitrile, THF, diethylether, dichloromethane, chloroform, carbon tetrachloride, benzene, toluene, hexane, and cyclohexane. The mass of each empty vial was recorded and then a specified amount of dried gel was added to each vial. The vials were weighed and the amount of dried gel was noted (W_{dry}). The vials were then filled with a solvent and allowed to equilibrate for 24, 48 and 72 hours. The excess solvent was removed from the vials and the gels were weighed again (W_{wet}). The amount of solvent absorbed by the gels was obtained from the difference in weights. The swelling degree (Q) was defined by Equation 1.

Temperature dependence on swelling degree of NG-18-1% gel was measured in the above solvents at 20, 40, 60, (60→) 0, and (25→) 0° C. Here, (60→) 0° C. indicates that the sample was heated at 60° C. to achieve the equilibrium once and then cooled to 0° C. This was performed to investigate the record of the heating and cooling process. Due to low boiling points, dichloromethane and diethylether were not used at 40° C.; similarly acetone was not used at 60° C. Likewise, DMSO and cyclohexane were not used at 0° C. due to high freezing points. These values were indicated as Q=0. To understand the kinetics of swelling behavior, the above procedure was followed with several vials and the amount of solvent absorbed was determined at different time intervals.

### Critical Temperature Studies

Critical temperatures were determined by UV-vis spectroscopy. Swollen NG-18-1% gel in THF was placed in a temperature controlled quartz cell, which was monitored with thermocouples (OMEGA DP462). The transmittance at 700 nm was measured as a function of temperature by changing temperature at 0.1° C./min. While the swollen gel was transparent, the collapsed gel was opaque. The values of critical temperature in the heating and cooling process were obtained from a plot of transmittance versus temperature.

### Cyclic Temperature Change Test

Cyclic temperature changes of both swelling degree and transmittance were performed to ascertain the reversibility of the gel. In the swelling test, a piece of NG-18-1% gel was first placed in THF for 48 h at 25° C. Excess THF was removed from the vial, weighed, and the swelling degree was calculated. Then the vial was filled with THF again, placed at 0° C. for 24 h, and swelling degree was measured by the same procedure. This cycling was repeated five times in total. In the transmittance study, THF swollen gels were placed in a temperature controlled quartz cell. The transmittance at 700 nm was measured at 25° C. and 0° C. alternatively. Each step took about 30 min, and the procedure was repeated for a total of five cycles. The gels achieved equilibrium values at each step in both swelling and transmittance test.

### Compression Strength

A piece of dried NG-18-1% and 0.5% gels was swelled by adding excess toluene or THF. After eliminating extra solvent, compression strength was measured at a compression speed of 0.5 mm/min.

### Oil Absorption

Stainless steel metal coupons were washed by acetone and methanol, and dried in vacuo for 72 hours. The coupons were soaked in SAE-30 oil and allowed to drip excess oil for 30 minutes. Half of these coupons were also sprayed with alumina powder. The contaminated coupons were immersed in NG-18 gels or toluene for 30 minutes. The percent of oil absorbed was then measured by comparing the weight of each coupon before and after immersion.

Analogous procedure was followed for field samples obtained from a Naval cleaning facility.

### Grease Cleaning

Metal coupons were prepared according to MIL-PRF-680B (Appendix A), and uniformly coated with MIL-PRF-10924 grease. Beakers with the NG-18 gels and trichloroethylene (TCE) were placed into an ultrasonic cleaner. The test was started with a timer. The coupons were observed until all grease was visibly removed from the metal coupon, and the time was recorded in minutes. If a portion of grease remained on the metal coupon after 100 minutes, the test was immediately terminated with the testing time being recorded as 100 minutes. The cleaning power was determined by the equation:

$$Solvent cleaning power \% = ( \frac{100 - A}{100} ) \times 100 \qquad Eq . ( 2 )$$

where A is the average cleaning time in minutes of the three tested runs [18].

### Results and Discussion

### Characterization of NG-18 Gels

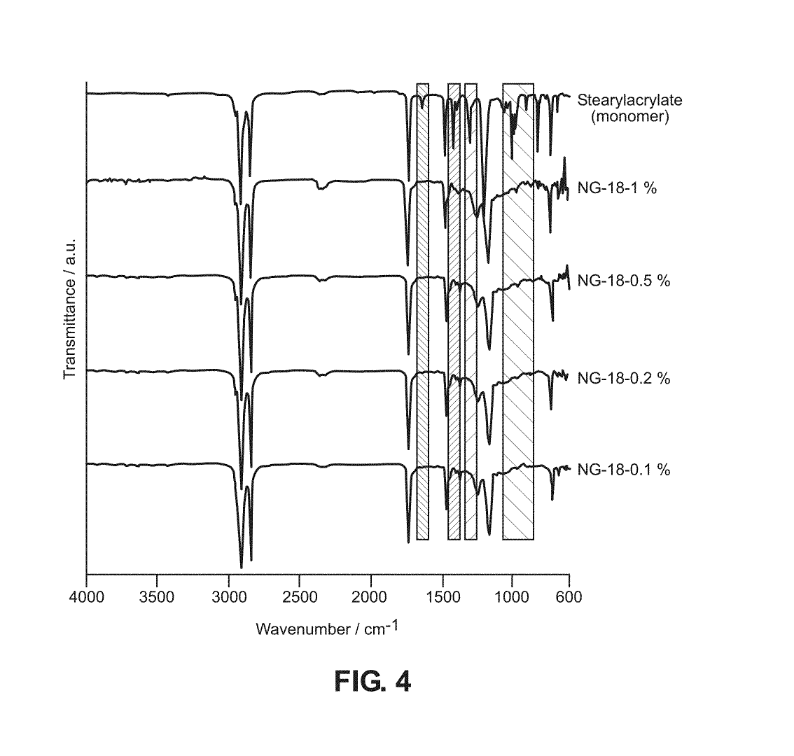

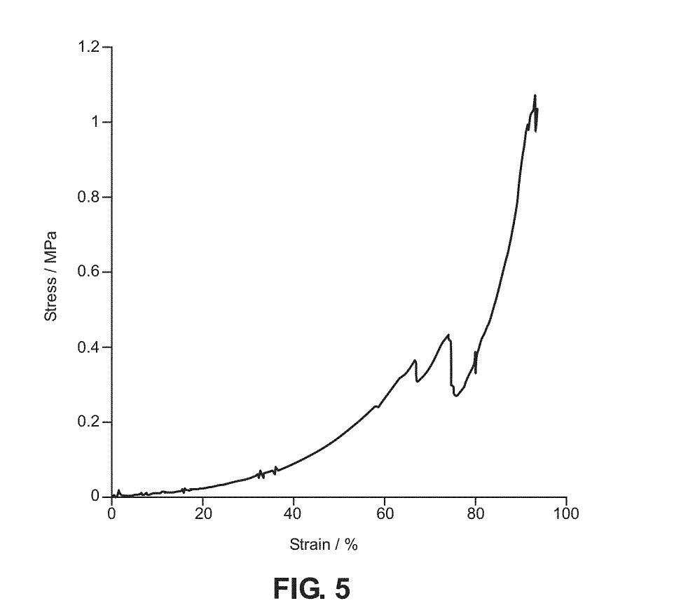

FT-IR spectra of SA monomer and NG-18-1%, −0.5% are provided in FIG. 4. Compared to the spectrum of stearylacrylate monomer, NG-18 gels showed the disappearance of peaks in four regions. Each peak was identified as follows: 1634 cm⁻¹ is C═C bond vibration, 1410 cm⁻¹ is C—H of C═CH₂ in-plane scissoring, 1297 cm⁻¹ is C—H of C═CH in-plane vibration, and 997 and 893 cm⁻¹ are C═CH out-plane vibration. The disappearance of these peaks of the vinyl group indicates that NG-18 gels include a little non-reacted SA. FIG. 5 shows the compression strength of swollen NG-18-1% gel in THF. The first breaking point is the stress of 0.371 MPa and the fracture strain of the gel is λ=67%. The NG-18-1% gel could withstand a similar degree of compression as reported by single network poly acrylamide gel prepared by Gong et al. [11].

### Swelling Behavior

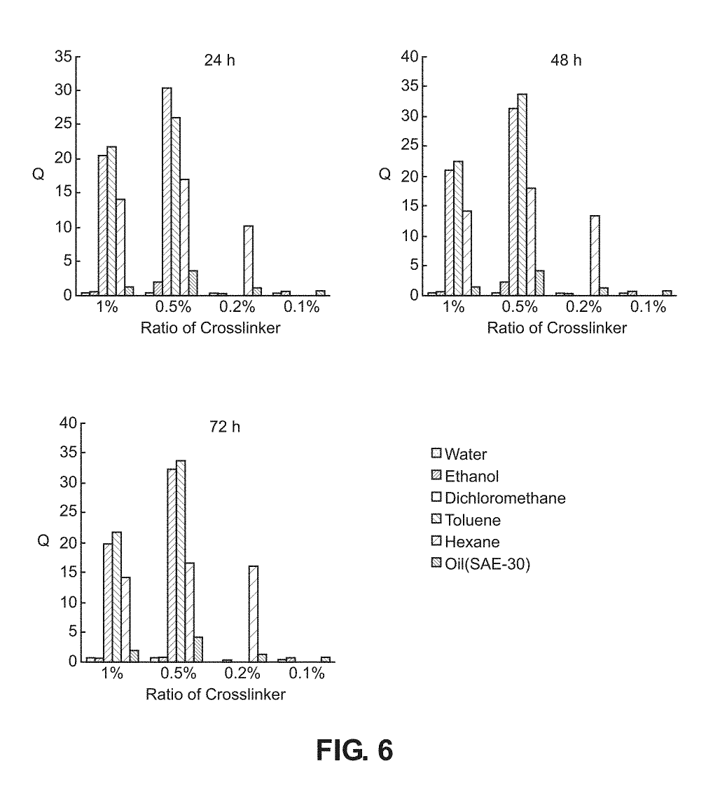

The swelling behavior of NG-18 gels (NG-18-1% and −0.5%) in solvents with various polarities from cyclohexane to water at 25° C. over the time periods of 24, 48 and 72 hours were investigated (FIG. 6). The swelling degree increased with increasing polarity from cyclohexane, and the maximum value was observed in chloroform. On the other hand, the gels collapsed in the more polar solvents (dielectric constant ε>10). Particularly, NG-18 gels absorbed large amounts of chlorinated solvents such as chloroform (Q=35 on NG-18-1%) and carbon tetrachloride (Q=36). Moreover, NG-18 swelled in a moderate amount of solvents such as ether (diethylether: Q=12, THF: Q=17), aromatic compounds (benzene: Q=21, toluene: Q=22), and aliphatic reagents (hexane: Q=14, cyclohexane: Q=20). In more polar solvents, such as water, DMSO, alcohols (methanol, ethanol, isopropanol, and 1-octanol), ketones (acetone and MIBK), and acetonitrile, NG-18 didn't swell at all (Q<1). Also, enhancing swelling ability by reducing the cross linker density was attempted. Reducing the feed ratio of the crosslinker to the monomer from 1 mol % to 0.1 mol % enhanced the swelling ratio. However, the gels less than 0.2 mol % crosslinker density were too soft to separate excess solvent and swelling degree could not be accurately measured. NG-18-0.5% indicated the same tendency as NG-18-1% and had a higher swelling degree than NG-18-1%. These swelling behaviors of NG-18 gels essentially depend on the compatibility of the polymer chain with the media. NG-18 didn't allow penetration of the highly polar molecules into the polymer networks, while non-polar solvents were absorbed.

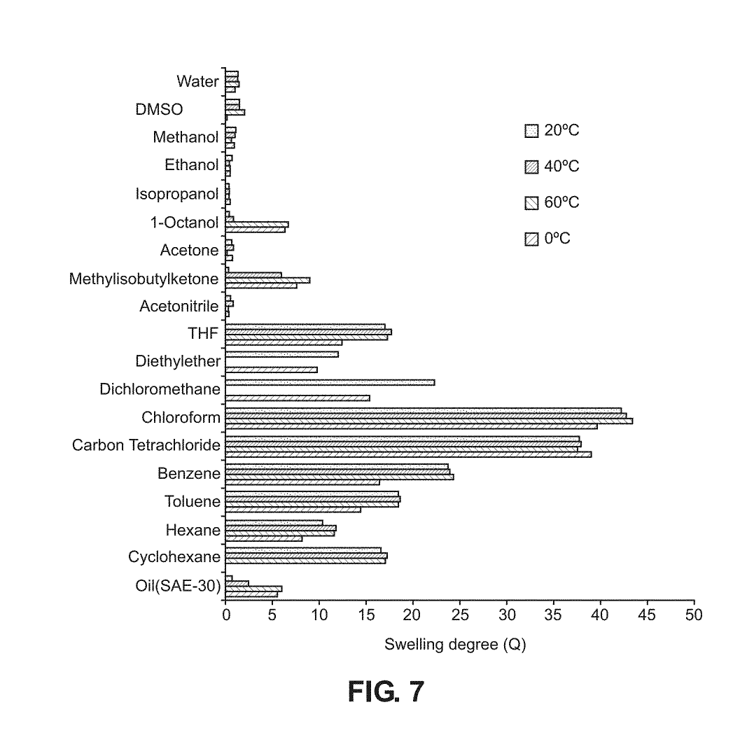

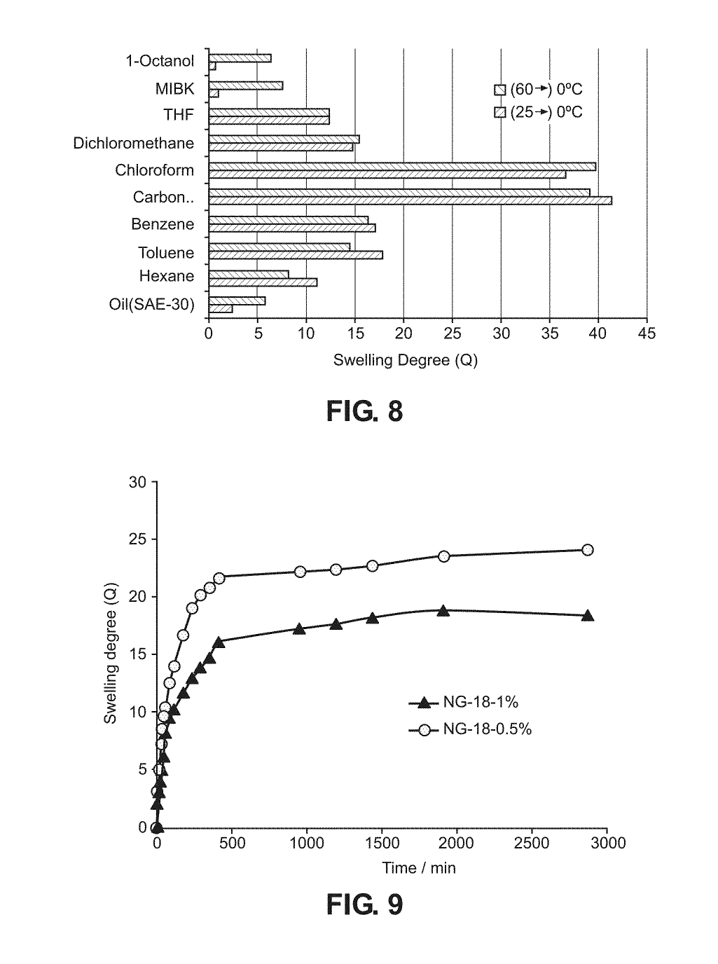

Subsequently, temperature dependence on the swelling degree with NG-18-1% gel was examined in FIG. 7. The temperature was changed from 20° C. to 40, 60, and 0° C. successively, and the variety of solvents is the same as ones used in swelling degree test at 25° C. Also, the sample cooled from 25° C. to 0° C. was studied to investigate the influence of thermal temperature changes during the heating process for swelling behavior, which is represented as (25→) 0° C. The comparison between (60→) 0° C. and (25→) 0° C. was summarized in FIG. 8.

The results in FIG. 7 were categorized as follows: 1) In the following solvents swelling degree did not change in both heating and cooling processes: water, DMSO, methanol, ethanol, isopropanol, acetone, acetonitrile, carbon tetrachloride, and cyclohexane. 2) Whereas the Q value didn't change by heating a maximum of 25 wt % of the following solvents was dislodged from the gel in cooling process: THF, diethylether, dichloromethane, chloroform, benzene, toluene, and hexane. 3) The swelling degree increased by heating, but was almost the same by cooling in the solvents 1-octanol and MIBK. The second category is especially remarkable because it showed the changes of swelling degree and the color change from transparent to opaque by cooling to 0° C. These transition behaviors are attributable to crystallization of long-alkyl chain among stearylacrylate. It is expected that this ability can be utilized to develop a VOC recycling system composed of both uptake and ejection. On the other hand, the transitions in the third category were irreversible as shown in FIG. 8.

Additionally, in order to determine the time dependence on the swelling degree of NG-18 gels in THF, the swelling ratio was determined as a function of time. FIG. 9 shows the time required for each gel to reach the equilibrium swelling degree. A cubic dry gel (NG-18-1%, -0.5%), 5 mm on a side, was placed in a vial with excess THF at 25° C.

The kinetics of the swelling behavior was examined by fitting the data to Lagergren pseudo-first and pseudo second order kinetic equations [20-22]:

$$\begin{matrix}\frac{{dq}_{t}}{dt} = {k}_{1} ( {q}_{e} - {q}_{t} ) & Eq . ( 3 ) \\ \frac{{dq}_{t}}{dt} = {{k}_{2} ( {q}_{e} - {q}_{t} )}^{2} & Eq . ( 4 )\end{matrix}$$

The values of the first and second order rate constants obtained through the linearization of equations 3 and 4 are included in Table 1, along with the values of the regression coefficient, R², which describes the correlation between graphed points with one being the best possible correlation and zero being the worst. A second order kinetic equation better describes the swelling behavior of NG-18 gels because the regression coefficient is closer to one.

TABLE 1
Lagergren first and second order rate constants (k1 and k2)
for swelling of the NG-18 gels

| | | | Second order | |
|---|---|---|---|---|
| | First order | | k₂, g g⁻¹ | |
| Sample | k₁ min⁻¹ | R² | min⁻¹ | R² |
| NG-18-1% | 4.38 × 10⁻³ | 0.971 | 5.55 × 10⁻⁴ | 0.998 |
| NG-18- | 5.30 × 10⁻³ | 0.985 | 5.72 × 10⁻⁴ | 0.999 |
| 0.5% | | | | |

### Critical Solution Temperature

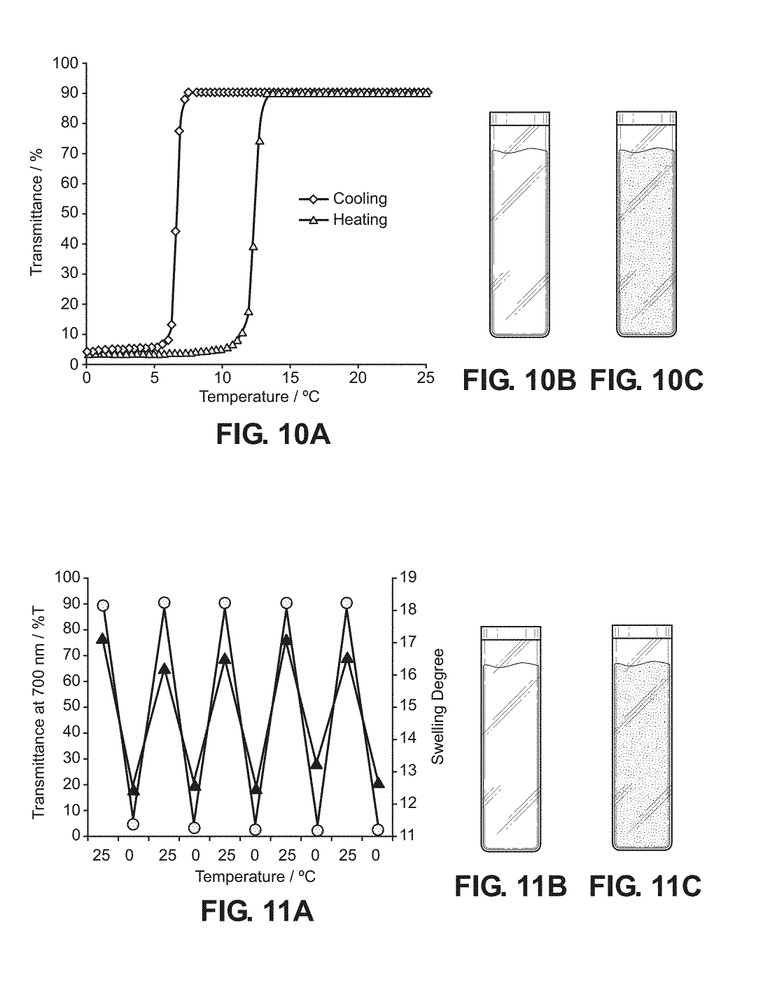

Critical solution temperature was determined for swollen NG-18-1% in THF. FIG. 10 shows the result obtained at 700 nm. The swollen gel is relatively transparent, while the collapsed gel is opaque. Thus, the transmittance values sharply change when the gel is collapsed. The transmittance values were plotted against temperature to obtain approximate critical temperature in both the heating and cooling processes. Transition temperature results in 6.6° C. in the cooling process and 12.4° C. in the heating process. This hysteresis was due to supercooling phenomenon on the cooling process. This transition process is different from N-isopropylacrylamide (NIPAM) in water, depending on the crystallization of long alkyl chain among stearylacrylate unit.

### Thermal Cycling of NG-18-1% Gels

The cyclic swelling degree and transmittance studies were performed in order to investigate the reversibility and reproducibility of the swelling behavior. The procedures were followed for five cycles for NG-18-1% gels and the results are shown in FIG. 11. The gel appears to be stable and retains its transition characteristics even after five cycles. In other words, this transition is reversible and non-destructive for the gel network. The change of transmittance is very fast and the color change occurs in less than 30 min, but the change of swelling degree was slow, taking more than 24 h. This means that the color change is part of the swelling process but the color change is not equivalent to the change of swelling degree.

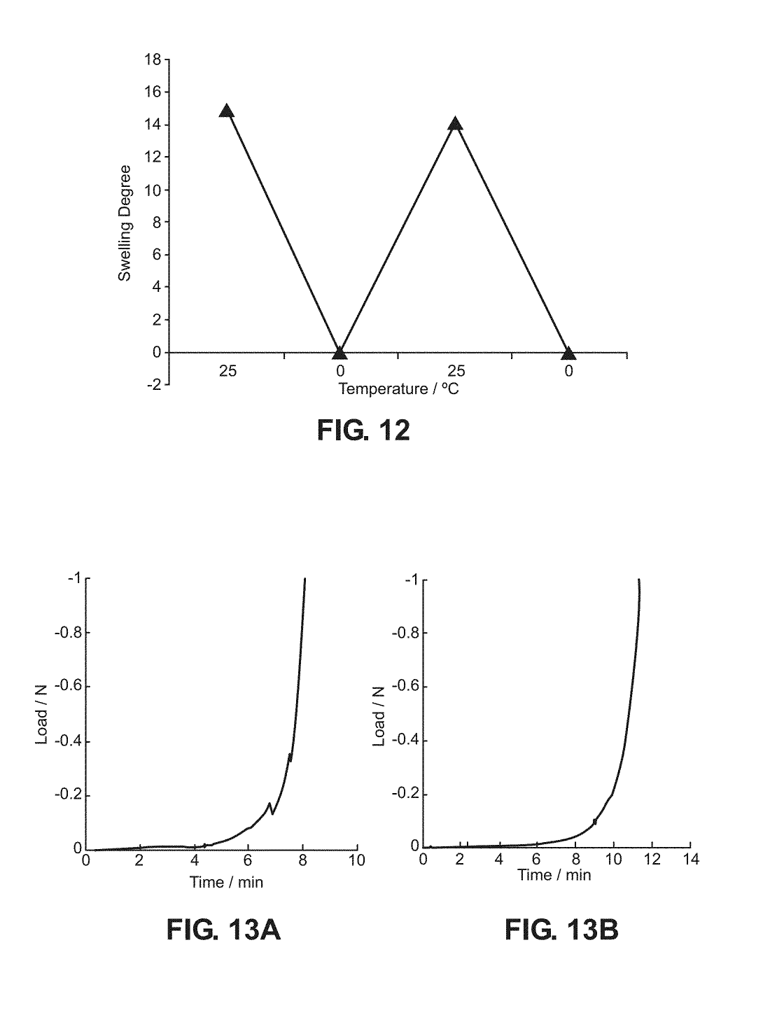

The cyclic swelling degree was also performed with the solvent cyclohexane. The procedures were followed for 3 cycles for NG-18-1% gels and the results are shown in FIG. 12. The gel is stable after three cycles. Cyclohexane is more environmentally benign than THF (Appendix B), and shows a similar swelling degree (Q=16 for cyclohexane and Q=17 for THF). Further testing of additional cycles will be carried out during the subsequent phases of this research.

### Compression Studies

The first breaking point is 0.167 N in NG-18-1% and about 1N in NG-18-0.5%. Compared to EG-18, NG-18 gels are much stronger (FIG. 13).

### Oil Absorption

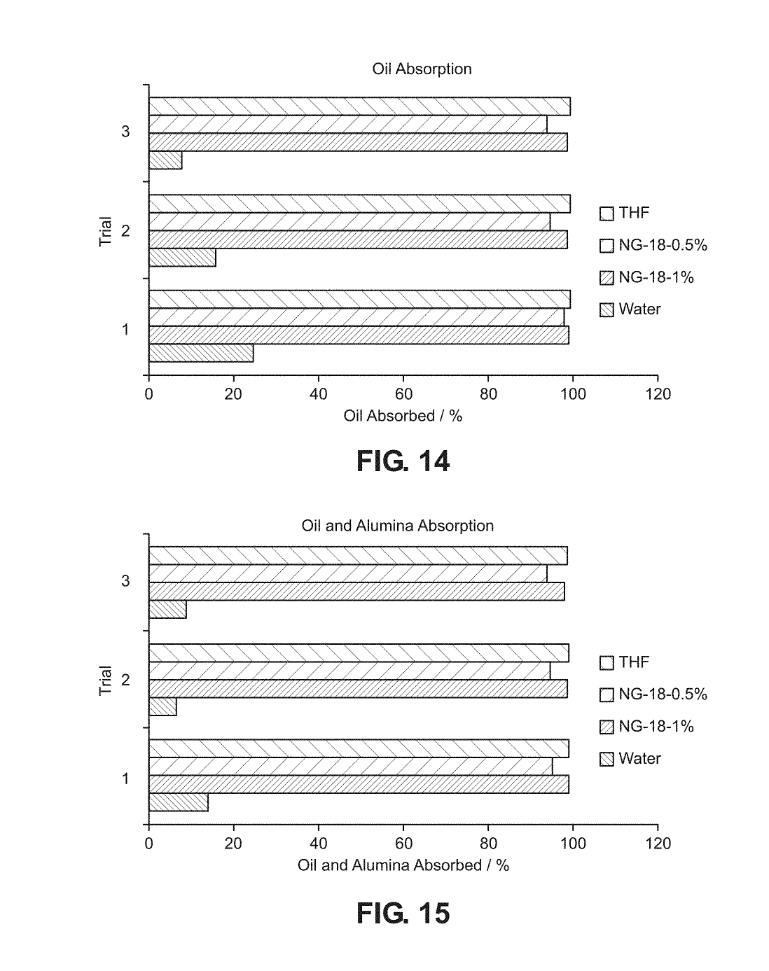

Oil absorption was tested with both NG-18 gels in toluene and in THF. The results of the tests with NG-18-X with swollen in THF are shown in FIGS. 14-15. It was determined that NG-18-1% in THF was the best performer in this category because of its high swelling degree, good recyclability, the high oil and alumina absorption properties. THF is also a relatively low- or non-toxic and environmentally friendly solvent. NG-18-0.5% gel was not able to clean all of the alumina powder and oil. Along with metal coupons, NG-18 gels were tested on painted coupons and stainless steel parts with bolts, the results of which are shown in the appendix C. The painted coupons did not show any signs of peeling, and the bolts and flat coupons were cleaned almost as well as using solvent by itself.

Temperature did change the swelling degree of NG-18-1% in 1-Octanol, methylisobutylketone, and SAE-30 oil when heating from 20° C. to 40 or 60° C. (FIG. 7). Even if they were cooled to 0° C., however, they did not collapse.

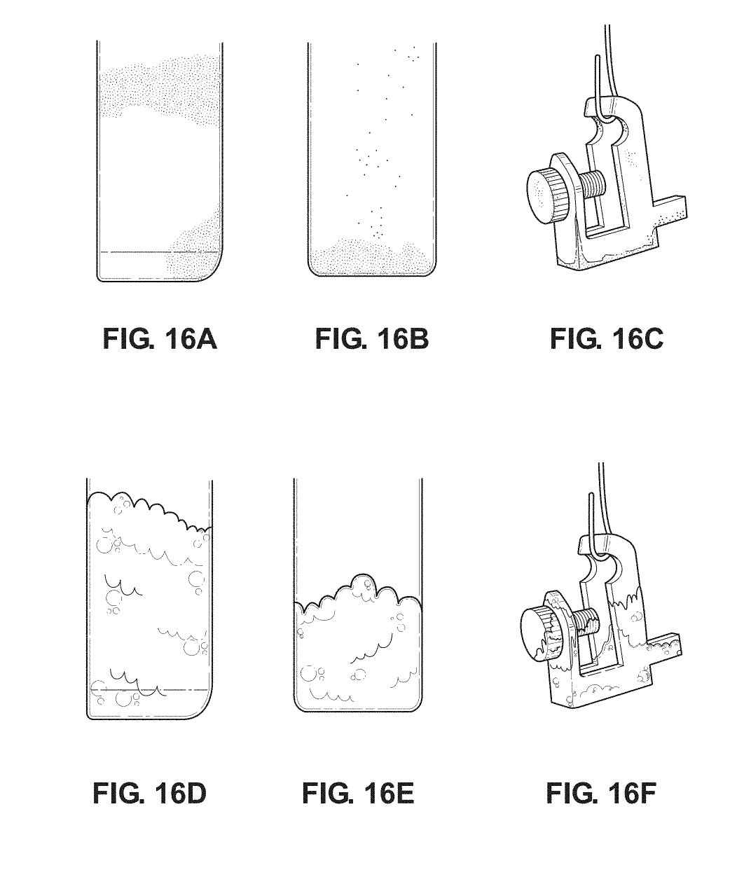

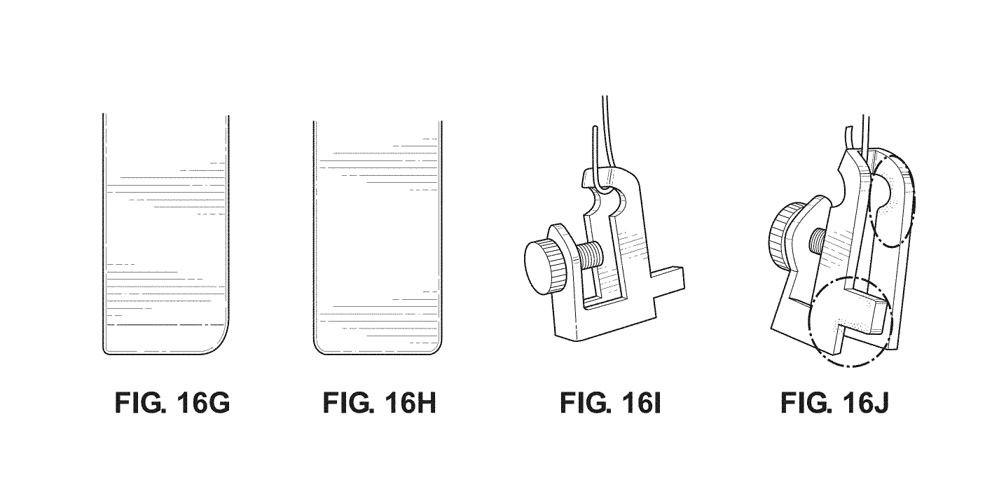

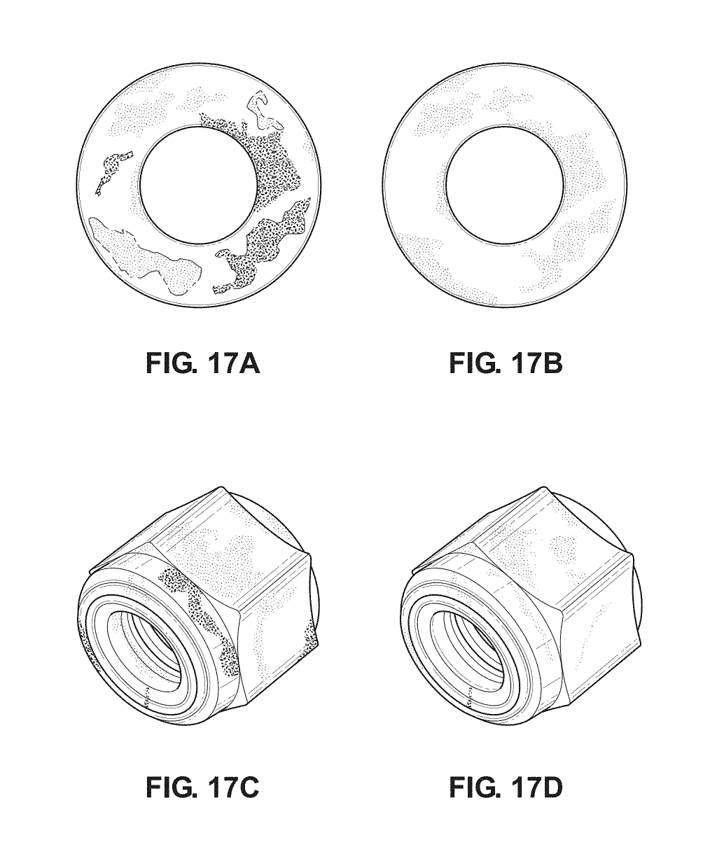

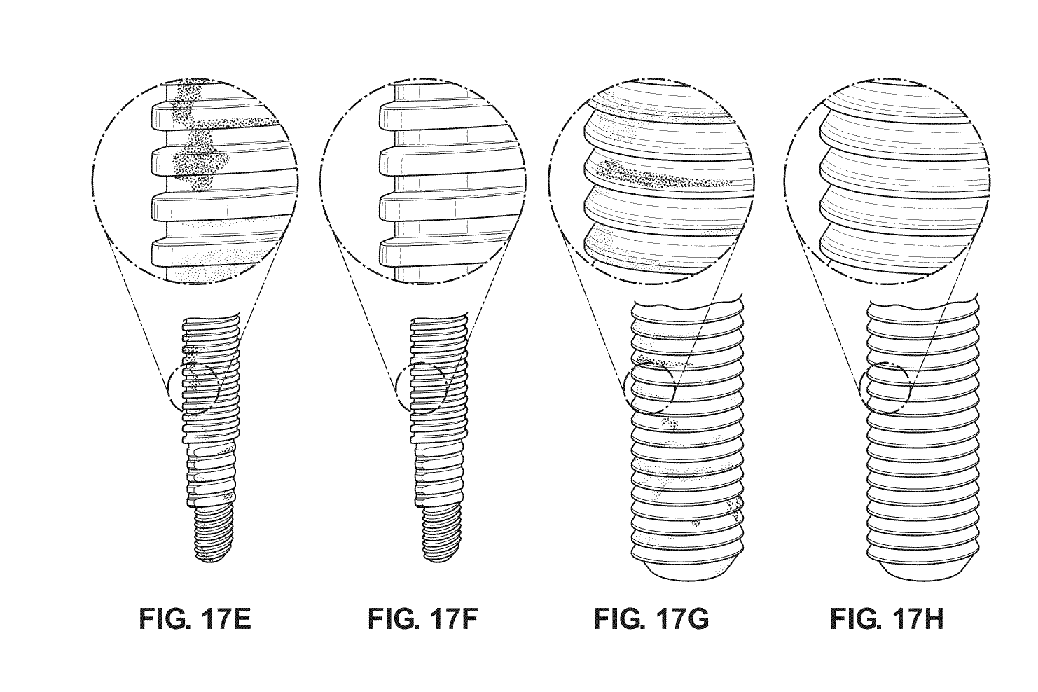

In addition to testing performed on metal coupons, field samples obtained from Portsmouth Naval Shipyard, Portsmouth, N.H. These parts include threaded sail adjustment screws, hydraulic valve stems, and miscellaneous nuts and washers. Some of these tested parts are shown in FIGS. 16a-17h. The samples consisted of large bolts and nuts approximately four to six inches long. Rusted materials can be cleaned of grease and oil, but not of rust, because rusting is a chemical process and not a physical process. Rusted parts in general are discarded.

### Grease Cleaning

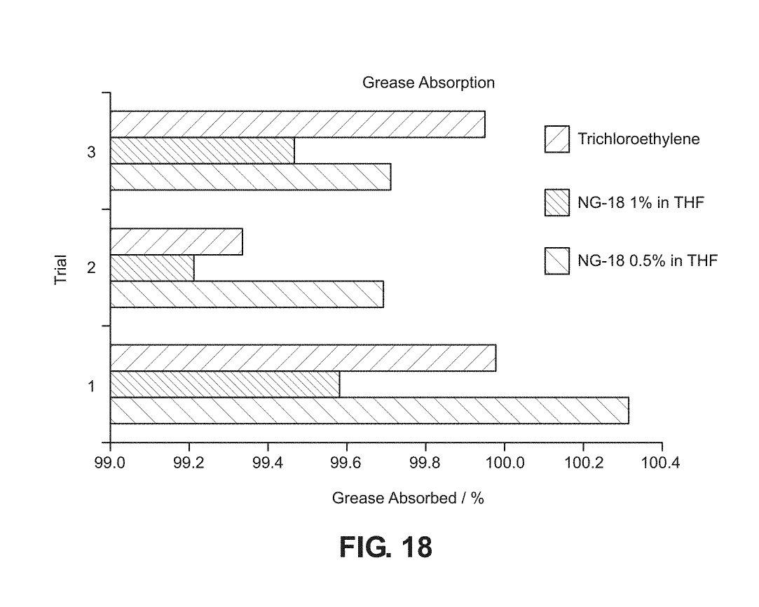

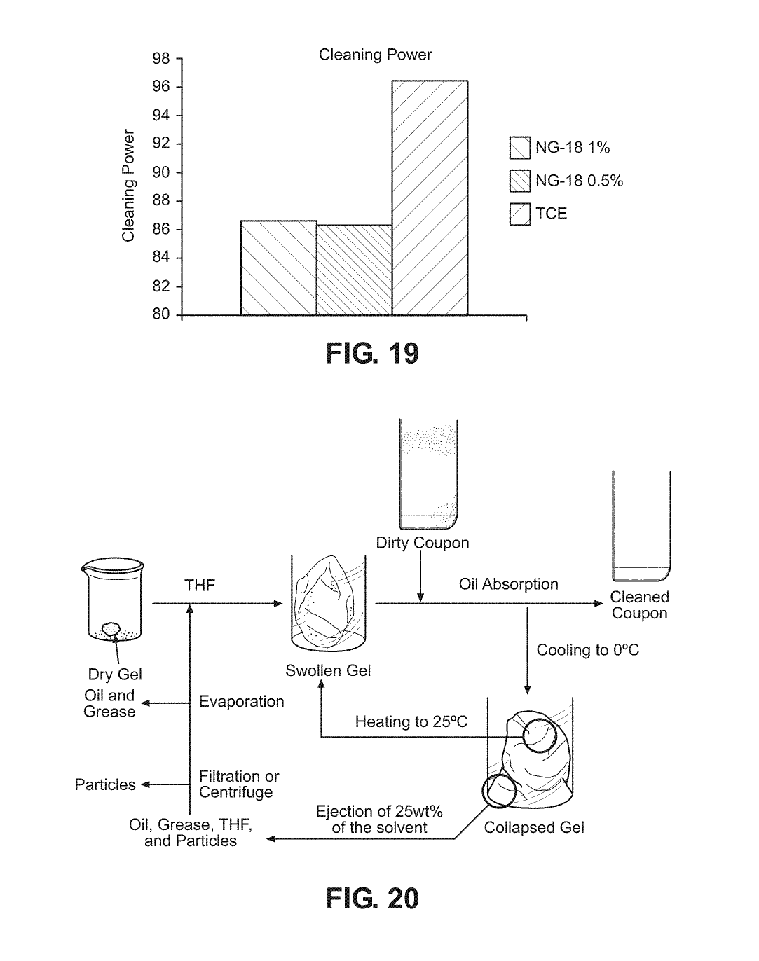

The grease absorption capabilities of NG-18 gels were comparable to trichloroethylene all showing greater than 99% absorption capabilities. As shown in FIGS. 18-19, NG-18-0.5% outperformed the TCE in two of three trials. NG-18-1% showed a greater cleaning power than NG-18-0.5% but had less grease absorption. This could be prevented further rinsing with ethanol immediately after cleaning if necessary.

### Recyclability of NG-18 Gels

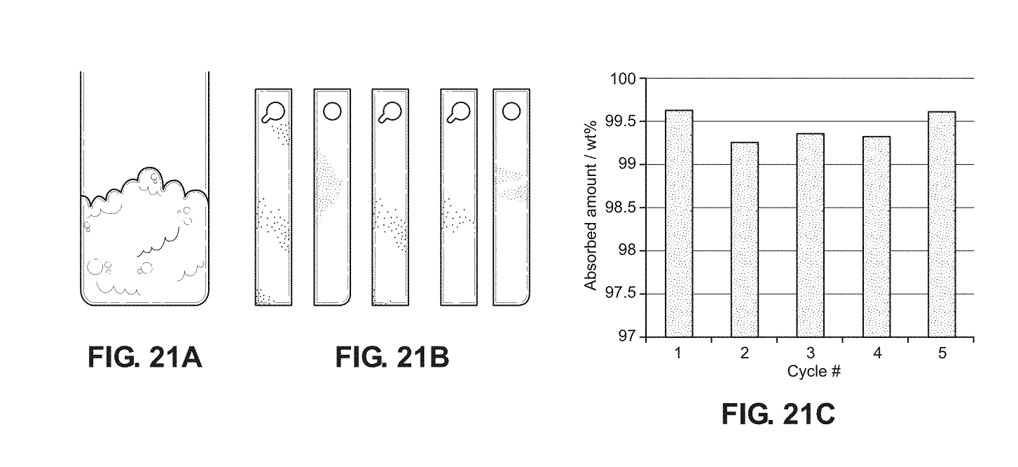

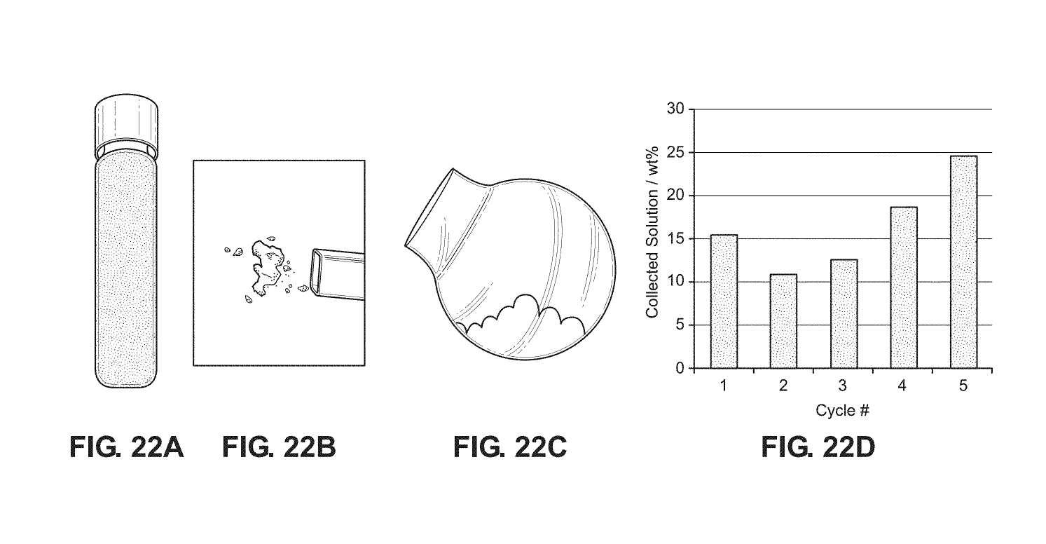

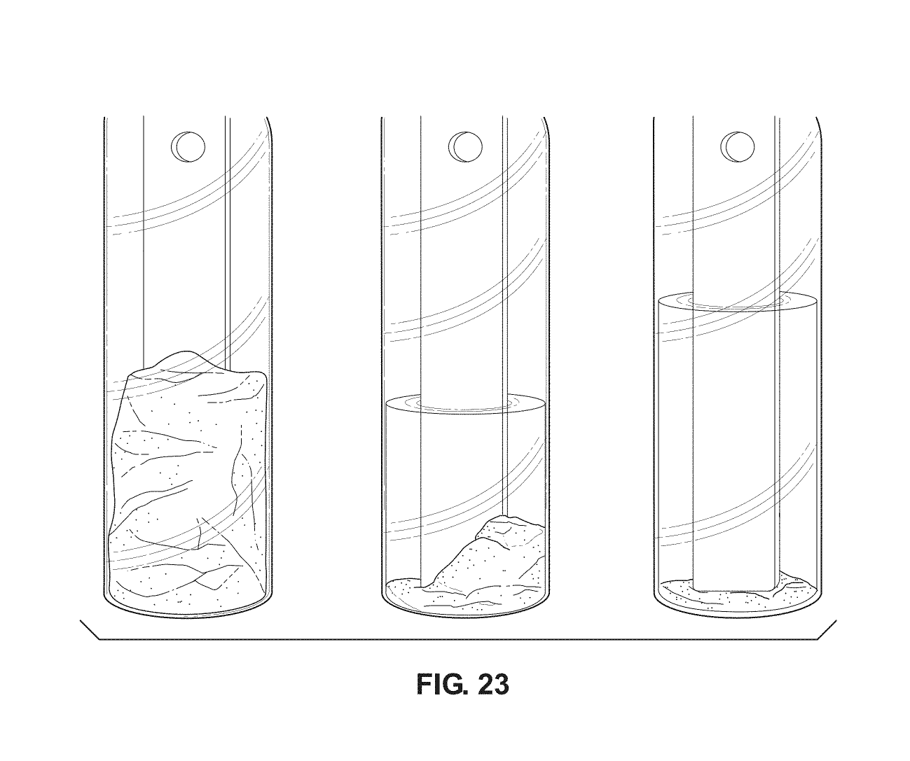

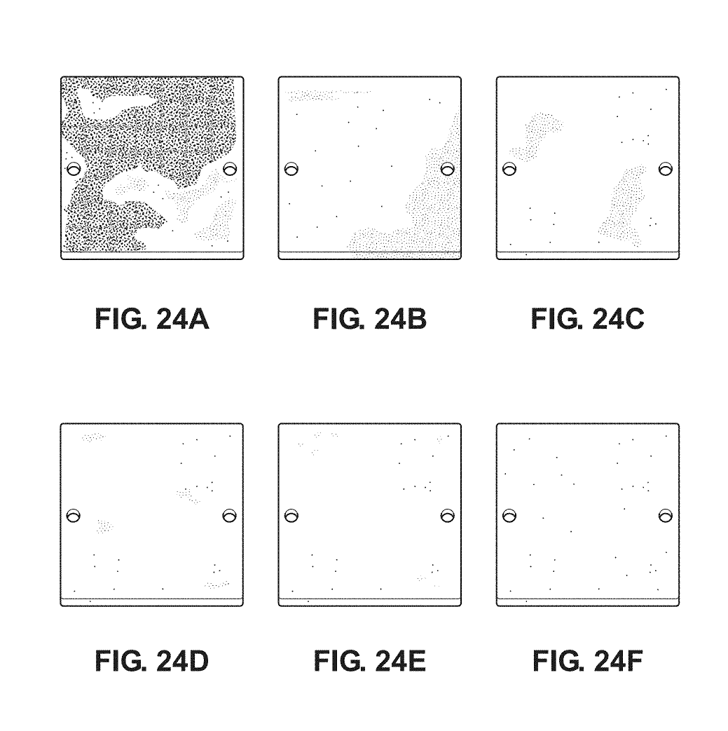

The recyclability of NG-18 1% gel for surface cleaning is illustrated in FIG. 20. This process is pending patent application [19]. The recyclability was tested by five consecutive oil absorption-desorption processes (FIGS. 21-22). The swelling degree of the gel in each step was not measured because the initial weight of the gel can change due to addition of oil and particulates. Instead, the amount of absorbed oil squeezed out by the collapsed gel was weighed in each step. The weight of the particulates and THF were accounted for by filtration, and evaporation, respectively.

The cleaning property of NG-18-1% gel was maintained at >99 wt % even after five cleaning cycles. By cooling, a solution containing particulate, THF, and oil was removed from the gel. The particles were removed by filtration, and 10-25% THF could be evaporated, recollected and recycled.

### Toxicity

Both THF and TCE are considered highly toxic in liquid form. THF is not used in liquid form in this experiment. Instead it is used in gel form, which will reduce exposure, and limit the health risks. Cyclohexane or other solvents may be used to address any toxic or environmental concerns.

### Conclusions

In this study, we first demonstrated the synthesis and characterization of poly(SA-co-EGDMA) (NG-18) gels. The swelling characteristics of the gels were studied as a function of the solvent polarity and temperature, and the kinetics of swelling were also examined. Volume transition via crystallization of the long alkyl chain was investigated by transmittance at 700 nm light with controlling temperature. Moreover, the reversibility and reproducibility of the transition were studied by both swelling and transmittance with cyclic temperature change. These properties suggested the utility of NG-18 gels as recyclable VOCs absorbent materials.

The gel system uses THF for swelling, however, cyclohexane or other benign solvents with similar swelling properties may also be used as a swelling agent. In particular cyclohexane is a good possibility with swelling ratio (Q) of 20. Other solvents such as toluene or other non-polar solvents may also be used. We have not tested several other potential solvents during this phase of the research.

Based on the preliminary cost assessment the gel cleaning process appears to be costing a similar amount. The gel cleaning process has the advantage of avoiding emissions of hazardous air pollutants (HAPs) and volatile organic compounds (VOCs).

Further research to improve the neutral gel systems with increased swelling properties and recyclability are recommended. Optimization of the gel synthesis, cleaning process and kinetics at room temperature is recommended.

It will be understood that many additional changes in the details, materials, procedures and arrangement of parts, which have been herein described and illustrated to explain the nature of the invention, may be made by those skilled in the art within the principle and scope of the invention as expressed in the appended claims. Moreover, the terms “about,” “substantially” or “approximately” as used herein may be applied to modify any quantitative representation that could permissibly vary without resulting in a change in the basic function to which it is related.

It should be further understood that the drawings are not necessarily to scale; instead, emphasis has been placed upon illustrating the principles of the invention.

### REFERENCES CITED

The following bibliography provides citations to the references cited in the above text. The references are provided merely to clarify the description of the present invention and citation of a reference either in the bibliography below or in the specification above is not an admission that any such reference is “prior art” to the invention described herein.
(1) Ohmine, I.; Tanaka, T. Salt effects on the phase transition of ionic gels. J. Chem. Phys. 1982, 77, 5725-5729.
(2) Rubinstein, M.; Colby, R. H.; Dobrynin, A. V.; Joanny, J. F. Elastic modulus and equilibrium swelling of polyelectrolyte gels. Macromolecules 1996, 29, 398-406.
(3) Ono, T.; Sugimoto, T.; Shinkai, S.; Sada, K. Lipophilic polyelectrolyte gels as super-absorbent polymers for nonpolar organic solvents. Nat. Mater. 2007, 6, 429-433.
(4) Ono, T.; Sugimoto, T.; Shinkai, S.; Sada, K. Molecular design of super-absorbent polymers for organic solvents by cross-linked lipophilic polyelectrolytes. Adv. Fund. Mater. 2008, 18, 3936-3940.
(5) Ono, T.; Shinkai, S.; Sada, K. Discontinuous swelling behaviors of lipophilic polyelectrolyte gels in non-polar media. Soft Matter 2008, 4, 748-750.
(6) Iroh, J. O.; Bell, J. P.; Scola, D. A. Mechanical-Properties of Electropolymerized Matrix Composites. Chem. Mater. 1993, 5, 78-83.
(7) Beebe, D. J.; Moore, J. S.; Bauer, J. M.; Yu, Q.; Liu, R. H.; Devadoss, C.; Jo, B. H. Functional hydrogel structures for autonomous flow control inside microfluidic channels. Nature 2000, 404, 588-590.
(8) Yoshida, R.; Uchida, K.; Kaneko, Y.; Sakai, K.; Kikuchi, A.; Sakurai, Y.; Okano, T. Comb-Type Grafted Hydrogels with Rapid De-Swelling Response to Temperature-Changes. Nature 1995, 374, 240-242.
(9) Tanaka, T.; Fillmore, D. J. Kinetics of swelling of gels. J. Chem. Phys. 1979, 70, 1214-1218.
(10) Trivedi, H. K.; Massey, M. L.; Bhattacharya, R. S.; Strahl, G. A.; Collum, D. Cleaners for military machine parts—is there a green alternative? J. Clean. Prod. 2004, 12, 771-780.
(11) Gong, J. P.; Katsuyama, Y.; Kurokawa, T.; Osada, Y. Double-network hydrogels with extremely high mechanical strength. Adv. Mater. 2003, 15, 1155-1158.
(12) Ito, K. Novel cross-linking concept of polymer network: Synthesis, structure, and properties of slide-ring gels with freely movable junctions. Polym. J. 2007, 39, 489-499.
(13) Laidler, K. J.; Meiser, J. H. Physical Chemistry; Third ed.; Houghton Mifflin Company: Boston, Mass., 1999.
(14) Strauss, S. H. The search for larger and more weakly coordinating anions. Chem. Rev. 1993, 93, 927-942.
(15) Krossing, I.; Raabe, I. Noncoordinating anions—Fact or fiction? A survey of likely candidates. Angew Chem. Int. Edit. 2004, 43, 2066-2090.
(16) Reed, C. A. Carboranes: A new class of weakly coordinating anions for strong electrophiles, oxidants, and superacids. Acc. Chem. Res. 1998, 31, 133-139.
(17) Kiyonaka, S.; Sada, K.; Yoshimura, I.; Shinkai, S.; Kato, N.; Hamachi, I. Semi-wet peptide/protein array using supramolecular hydrogel. Nat. Mater. 2004, 3, 58-64.
(18) MIL-PRF-680B Degreasing Solvent. (2006) http://www.wbdg.org/ccb/FEDMIL/prf680b.pdf (Accessed, August 2011).
(19) “Oil and Greese removal lipophilic polymer neutral gels” Patent disclosure submitted to US Army Corps OF Engineers Counsel June, 2011
(20) Ho Y S, Mckay G (1998) A comparison of chemisorption kinetic models applied to pollutant removal on various sorbents. Trans IChemE 76:332-340
(21) Rathna G V N, Chaterji P R (2001) Swelling Kinetics and mechanistic aspects of thermosensitive interpenetrating polymer networks. J Macromol Sci A38:43-56
(22) Saraydin D. Caldiran Y (2001) In vitro dynamic swelling behaviors of polyhydroxamic acid hydrogels in the simulated physiological body fluids. Polym Bull 46:91-98

What is claimed is:

1. A cleaning process for a surface having contaminants thereon using a lipophilic, highly absorbent swelling gel having solvent absorbed therein, said process comprising the steps of:
(i) combining a dry lipophilic, highly absorbent swelling gel with an initial amount of solvent to form a swollen gel,
(ii) contacting said surface having contaminants thereon with said swollen gel, said swollen gel being at a cleaning temperature,
(iii) said contaminated surface and said swollen gel remaining in contact for a period of time to remove said contaminants from said surface and transfer said contaminants to said swollen gel, and forming a dirty gel, and
(iv) removing said surface from said dirty gel, wherein at least 80% by weight of said contaminants have been removed from said surface.

2. The process of claim 1 further comprising a gel recycling process, wherein said gel also has a property of collapsing when solvent is ejected, and wherein after said surface removal in step (iv),
(v) said dirty gel is cooled to a solvent ejection temperature,
(vi) thereby forming a cooled, collapsed gel and an amount of ejected solvent, said ejected solvent being an amount up to about 25% by weight of said initial amount of solvent, and wherein said ejected solvent contains at least about 95% by weight of said removed contaminants,
(vii) said cooled, collapsed gel is heated to said cleaning temperature, and an amount of make-up solvent is added, said amount of make-up solvent being substantially equal to said amount of ejected solvent, thereby forming a swollen gel, and
repeating steps (ii) through (vii).

3. The process of claim 2 further comprising a solvent recycling step wherein said ejected solvent is separated from said removed contaminants to from recycled solvent, and said recycled solvent is used as a part of or all of said make-up solvent.

4. The process of claim 1 wherein said surface is selected from the group consisting of an unpainted metal surface, a painted metal surface and a non-metal surface.

5. The process of claim 2 wherein steps (ii) through (vii) are repeated five or more times.

6. The process of claim 1 wherein said dry gel is selected from the group consisting of a lipophilic polyelectrolyte gel, a lipophilic neutral gel and combinations thereof.

7. The process of claim 1 wherein said solvent is selected from the group consisting of tetrahydrofuran, diethylether, dichloromethane, chloroform, benzene, toluene, hexane, cyclohexane and combinations thereof.

8. The process of claim 2 wherein said ejected solvent contains at least about 98% by weight of said removed contaminants.

9. The process of claim 1 wherein said cleaning temperature is in the range from about 15° C. to about 45° C.

10. The process of claim 1 wherein said cleaning temperature is in the range from about 22° C. to about 28° C.

11. The process of claim 2 wherein said solvent ejection temperature is in the range from about minus 5° C. to about 5° C.

12. The process of claim 2 wherein said solvent ejection temperature is in the range from about minus 2° C. to about 2° C.

13. The process of claim 6 wherein said lipophilic polyelectrolyte gel is an octadecylacrylate-co-ethylene glycol dimethacrylate gel.

14. The process of claim 6 wherein said lipophilic neutral gel is a poly(stearylacrylate-co-ethylene glycol dimethacrylate) gel.

15. The process of claim 1 wherein said contaminants comprise contaminants selected from the group consisting of oil, grease, particulates and combinations thereof.

16. The process of claim 1 wherein said gel is a lipophilic neutral gel comprising poly(stearylacrylate-co-ethylene glycol dimethacrylate) gel, said solvent is tetrahydrofuran, said contaminants comprise grease, and at least 99% by weight of said grease has been removed from said surface.

17. The process of claim 14 wherein the ratio x of EGDMA crosslinker to SA monomer is from 0.2 to 2.0 mole %.

18. The process of claim 17 wherein the ratio x of EGDMA crosslinker to SA monomer is from 0.8 to 1.2 mole %.

19. The process of claim 5 wherein said gel is a lipophilic neutral gel comprising poly(stearylacrylate-co-ethylene glycol dimethacrylate) gel, said solvent is tetrahydrofuran, said contaminants comprise grease, the ratio x of EGDMA: SA is 1.0 mole %, and at least 99% by weight of said grease has been removed from said surface after each of said five or more cleaning cycles.

20. The process of claim 1 wherein said period of time in step (iii) is from about 10 minutes to about 20 minutes.
